(19) United States
(12) Patent Application Publication
(10) Pub. No.: US 2017/0068789 A1
(43) Pub. Date: Mar. 9, 2017

(54) EVIDENCE-BASED CLINICAL DECISION SYSTEM

(71) Applicants: H. LEE MOFFITT CANCER CENTER AND RESEARCH INSTITUTE, INC., Tampa, FL (US); MOFFITT GENETICS CORPORATION (DBA M2GEN), Tampa, FL (US)

(72) Inventors: William S. Dalton, Temple Terrace, FL (US); Eric B. Haura, Tampa, FL (US); Naveen Kumar, Tampa, FL (US); Eric Padron, Tampa, FL (US); Kenneth H. Shain, St. Petersburg, FL (US); Eduardo M. Sotomayor, Tampa, FL (US)

(21) Appl. No.: 15/119,852

(22) PCT Filed: Feb. 19, 2015
(86) PCT No.: PCT/US2015/016641

§ 371 Date: Aug. 18, 2016

Related U.S. Application Data
(60) Provisional application No. 61/941,901, filed on Feb. 19, 2014.

(51) Int. Cl. G06F 19/00

(52) U.S. Cl. CPC G06F 19/345; G06F 19/3443

(57) ABSTRACT

Methods, systems, and apparatus, including computer programs encoded on a computer storage medium, including a system for providing treatment suggestions. The system includes a data warehouse including patient data for a plurality of patients associated with one or more care facilities, and one or more processors including instructions for implementing an evidence-based clinical decision engine. The engine is operable to: identify patient cohorts defined by the data in the data warehouse including identifying relevant cohorts that include a population of patients who are similar, both by phenotype and genotype, to a candidate patient; evaluate the patient cohorts to identify a cohort that is a best match for the candidate patient based on historical treatment information for patients in each candidate patient cohort; select a cohort from the plurality of cohorts; and provide a treatment suggestion to the patient or a care provider based on the selection.

### BACKGROUND

This specification relates to data evaluation tools relevant to the treatment of patients.

Patient data can be of various forms including both personal and clinical data. Management and evaluation of the data present a myriad of opportunities for identifying interesting groupings of patients. Challenges exist in collection, evaluation and use of the data.

### SUMMARY

This specification describes technologies relating to methods and systems for an evidence-based clinical decision (EBCD) engine and system that uses a data warehouse. The data warehouse includes, for example, patient data for a plurality of patients associated with one or more care facilities.

In general, one innovative aspect of the subject matter described in this specification can be embodied in systems. A system includes a data warehouse including patient data for a plurality of patients associated with one or more care facilities, and one or more processors including instructions for implementing an evidence-based clinical decision engine. The engine is operable to identify a plurality of patient cohorts that are defined by the data in the data warehouse including identify one or more relevant cohorts that include a population of patients who are similar, both by phenotype and genotype, to a candidate patient. The engine is further operable to evaluate the plurality of patient cohorts to identify a cohort that is a best match for the candidate patient based at least in part on historical treatment information for patients in each candidate patient cohort. The engine is further operable to, based on the evaluating, select a cohort from the plurality of cohorts. The engine is further operable to provide a treatment suggestion to one or more of the patient or a care provider based at least in part on the selection.

These and other embodiments can each optionally include one or more of the following features. The plurality of cohorts can be based at least in part on one or more of cultural, socioeconomic, psychological, environmental or other factors that influence patient outcomes. The data warehouse can include clinical data and molecular profiling data that is linked to a patient identifier. The engine can be enabled to capture information for storage in the data warehouse from disparate sources, including patient derived clinical data, tissue data, and genomic or molecular data, as well as data from open sources including publications and open source databases. The system can further include a computer network for tracking patients whose data is included in the data warehouse including tracking patients longitudinally throughout their lifetime. The engine can further be operable to routinely capture data for patients; analyze captured data; generate evidence through retrospective analysis of existing data as well as data from prospective studies; implement new insights into subsequent clinical care of one or more patient; evaluating outcomes from changes in clinical practice; and generate new hypotheses for investigation. The engine can further be operable to aggregate patient-level data, identify population-level based change, and apply results in the form of suggestions to care for individual patients to achieve best outcomes based on previous patient outcomes. The engine can further be operable to develop therapeutic and long-term treatment plans based on the past experience of similar patients existing in the data warehouse who are most similar to the candidate patient. The engine can utilize a continuous link prediction process for rapid knowledge generation by continuously applying data-driven link prediction, text analysis and knowledge visualization and continuously and automatically applying these capabilities over large real-time clinical and molecular data stored in the data warehouse for rapid learning. The engine can generate evidence for individual cancer patients based on data and outcomes analysis of patients previously enrolled in the data warehouse.

In general, another innovative aspect of the subject matter described in this specification can be embodied in methods that include the actions of: providing a data warehouse including patient data for a plurality of patients associated with one or more care facilities; identifying a plurality of patient cohorts that are defined by the data in the data warehouse including identify one or more relevant cohorts that include a population of patients who are similar, both by phenotype and genotype, to a candidate patient; evaluating the plurality of patient cohorts to identify a cohort that is a best match for the candidate patient based at least in part on historical treatment information for patients in each candidate patient cohort; based on the evaluating, selecting a cohort from the plurality of cohorts; and providing a treatment suggestion to one or more of the patient or a care provider based at least in part on the selection.

These and other embodiments can each optionally include one or more of the following features. Identifying the plurality of cohorts can be based, at least in part, on one or more of cultural, socioeconomic, psychological, environmental or other factors that influence patient outcomes. The data warehouse can include clinical data and molecular profiling data that are linked to a patient identifier. Providing the treatment suggestion can include capturing information for storage in the data warehouse from disparate sources, including patient derived clinical data, tissue data, and genomic or molecular data, as well as data from open sources including publications and open source databases. The method can further include tracking patients whose data is included in the data warehouse including tracking patients longitudinally throughout their lifetime. Providing the treatment suggestion can include routinely capturing data for patients, analyzing the captured data, generating evidence through retrospective analysis of existing data as well as data from prospective studies, implementing new insights into subsequent clinical care of one or more patient; evaluating outcomes from changes in clinical practice, and generating new hypotheses for investigation. The method can further include aggregating patient-level data, identifying population-level based change, and applying results in the form of suggestions to care for individual patients to achieve best outcomes based on previous patient outcomes. The method can further include developing therapeutic and long-term treatment plans based on the past experience of similar patients existing in the data warehouse who are most similar to the candidate patient. The method can further include utilizing a continuous link prediction process for rapid knowledge generation by continuously applying data-driven link prediction, text analysis and knowledge visualization and continuously, and automatically applying these capabilities over large real-time clinical and molecular data stored in the data warehouse for rapid learning. The method can further include producing evidence generation for individual cancer patients based on data and outcomes analysis of patients previously enrolled in the data warehouse.

Particular embodiments of the subject matter described in this specification can be implemented so as to realize none, one or more of the following advantages. The use of a data warehouse and an evidence-based clinical decision support tool provide, for example, an enhanced ability to match a patient to an appropriate treatment or clinical trial. Data gathering can be from plural sources and the tool can routinely analyze and update cohorts and provide suggestions not only for individual patients but also for areas of further research or development.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example healthcare environment.

FIG. 2 is a block diagram of an example architecture.

FIG. 3 is a block diagram of an example process for providing real-time decision support for healthcare providers and patients.

FIG. 4 is a flow diagram of an example process for providing treatment suggestions.

FIG. 5 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for an evidence-based clinical decision support tool and system. The support tool can be used, for example, to inform clinicians and patients of evidence and knowledge supporting best outcomes for individual patients based on the ability to identify a population of patients who are similar, e.g., both by phenotype and genotype. The support tool can use a computer system network and a data warehouse that contains patient data and that has the ability to identify patient cohorts (referred to as the Total Cancer Care System and Protocol, U.S. Pat. No. 8,135,595, which is incorporated herein in its entirety). Much of the current focus of personalized medicine is the use of molecular technologies (e.g., genomics) to create biomarkers that are diagnostic, prognostic, predictive and/or can direct therapy. However, personalized medicine is much wider and includes cultural, socioeconomic, psychological, environmental and other factors that influence patient outcomes. To improve the delivery of personalized medicine can require increasing the data available to generate evidence to support individualized treatments. Current information systems that support clinical decision making can depend on published literature (which may be both outdated or lack validation) or is lacking in the ability to integrate and analyze the vast amounts of clinical and molecular data required to identify relevant cohorts of patients who resemble an individual patient being seen in the clinic. Both healthcare providers and patients themselves can benefit from an evidence-based knowledge generation system to support diagnostic, therapeutic, and treatment planning decisions necessary for improved patient outcomes.

For patients seen at a point of care (e.g., clinics, hospitals, patients' homes), the data warehouse can store clinical data and molecular profiling data. For example, clinical data can include personal medical history, physical exam results, laboratory results, imaging results, and other standard data associated with care of the patient to include but not be limited to past and current medications, surgeries, and other forms of therapy. The molecular profiling data, for example, can include gene sequencing data, gene expression data and any genomics data. The clinical data and molecular profiling data can be linked to a patient identifier and deposited (extract, transfer and load) in the data warehouse. The data warehouse can be part of a computer network system which tracks oncology patients longitudinally throughout their lifetime. This computer network system can be the foundation for a “rapid knowledge generation environment” that “learns” by routinely and iteratively (1) collecting data in a planned and strategic manner; (2) analyzing captured data; (3) generating evidence through retrospective analysis of existing data as well as data from prospective studies; (4) implementing new insights into the subsequent clinical care; (5) evaluating outcomes from changes in clinical practice; and (6) generating new hypotheses for investigation. In this rapid learning environment, patient-level data can be aggregated to achieve population-level based change, and results can be applied to care of individual patients to achieve best outcomes based on previous patient outcomes. Importantly, newly enrolled patients can be assigned to a cohort of patients already populated in the data warehouse and are similar based on phenotype and genotype. Based on the evidence and knowledge generated by the system, options can be presented to the patient and healthcare provider that are predicted to result in “best” diagnostic and therapeutic outcomes for individual patients.

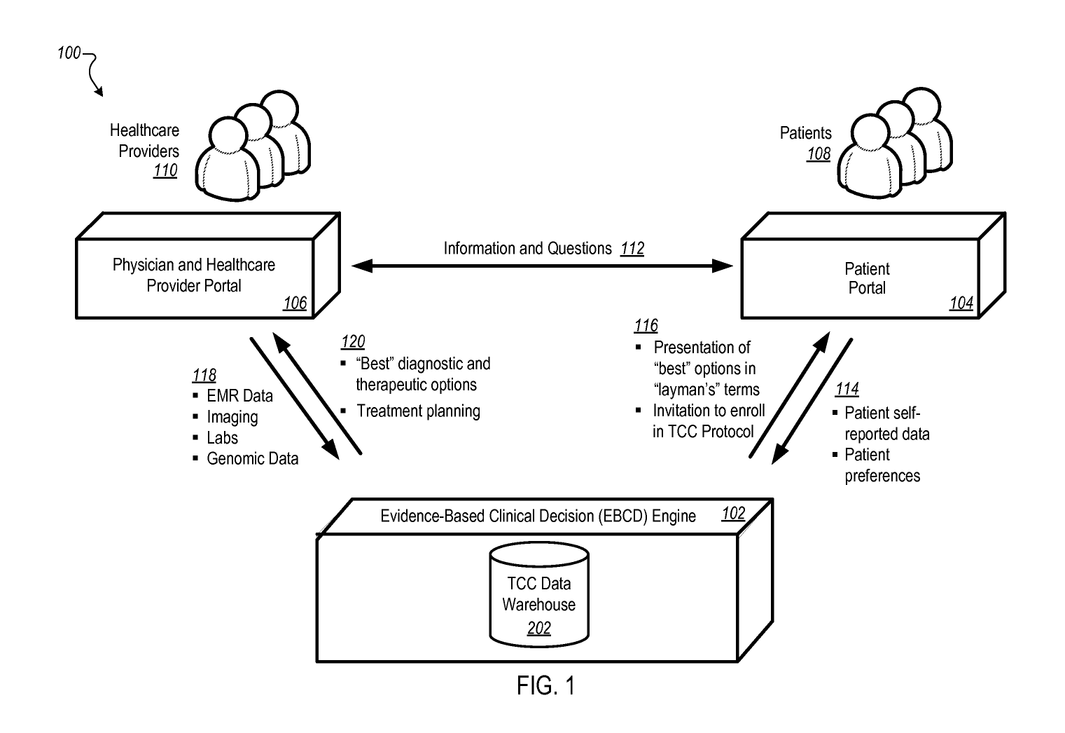

FIG. 1 is a block diagram of an example healthcare environment 100. FIG. 1 illustrates, for example, how patients 108 and healthcare providers 110 can both populate and curate data and communicate with each other in the decision-making process, including using a support tool such as an evidence-based clinical decision (EBCD) engine 102. In some implementations, the EBCD engine 102 can include a total cancer care (TCC) data warehouse (DW) and rapid knowledge generation environment. For example, the TCCDW can contain longitudinal clinical and laboratory data on all patients seen over the past 20 years or some other time period. Newly-enrolled patients being seen in a clinic, for example, can be associated with (e.g., assigned to) a cohort of patients already in the data warehouse who are similar both phenotypically and genotypically. The associations, for example, can provide information for knowledge-based decision making. Patients enrolled in a TCC protocol can enable a dynamic, interactive system that allows for lifelong studies of patients and creation of new knowledge. In some implementations, patients 108 can use at least one patient portal 104 for communicating with the EBCD engine 102. Further, healthcare providers 110 can use at least one physician and healthcare provider portal 106 for communicating with the EBCD engine 102.

In some implementations, treating physicians and patients have ability to push information and questions 112 to each other, e.g., using the portals 104 and 106. Patient sourced information 114 exchanged between the patient portal 104 and the EBCD engine 102 can include, for example, patient self-reported data and patient preferences. Patient received information 116 provided by the EBCD engine 102 to the patient portal 104 can include, for example, presentation information of topics in layman's terms. Provider sourced information 118 exchanged between the physician and healthcare provider portal 106 and the EBCD engine 102 can include, for example, electronic health record (EMR) data, imaging data, labs information, and genomic data. Patient provided information 120 provided by the EBCD engine 102 to the physician and healthcare provider portal 106 can include, for example, diagnostic and therapeutic options and treatment planning information.

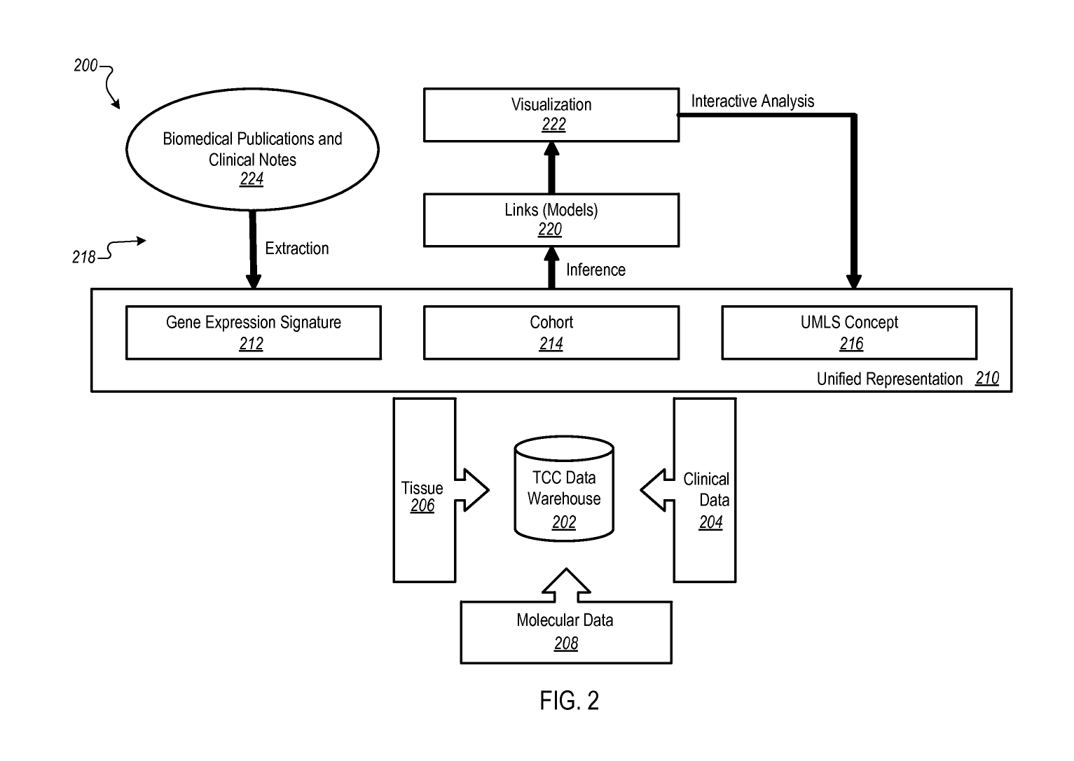

FIG. 2 is a block diagram of an example architecture for a system 200. For example, the system 200 can be associated with the evidence-based clinical decision engine 102. The system 200 can accommodate disparate sources of data (e.g., stored in a data warehouse 202), including patient-derived clinical data 204, tissue data 206, genomic or molecular data 208, and data from open sources including publications and open source databases. The data warehouse 202, for example, can support the integration of patient's clinical data, tissue and molecular data.

The system 200 can support the ability to describe individual patients using phenotypic and genotypic descriptors, provide for the understanding of the uniqueness of individual patients, and allow for patients to be compared using a process of cohort identity. Individual patients can be “assigned” to similar patient cohorts who are already enrolled in the data warehouse, and the outcomes of these cohorts can allow for the system 200 to predict outcomes based on clinical history of therapy and other interventions used to treat similar patients. Using the information, both patients and healthcare providers can consider the many factors that determine patient outcomes. The patients and healthcare providers can also use the evidence-based clinical decision engine 102 to develop therapeutic and long-term treatment plans based on the past experience of similar patients existing in the data warehouse who are most similar to the patient in question. In this system 200, both patients and healthcare providers can have access to the same data and recommendations based on analytics provided by the system. This common access can harmonize the approach and increase understanding for both patients and healthcare providers. The architecture of the system 200 can also facilitate communication across all stakeholders who are using the same resource of evidence and knowledge that will ultimately allow understanding of value for diagnostics and interventions and influence decisions of coverage for healthcare.

The system 200 can include, for example, a unified representation 210 of gene expression signature data 212, cohort information 214, and Unified Medical Language System (UMLS) vocabularies and concept information 216. In some implementations, in processes 218 that uses the unified representation 210, links 220 (e.g., models) can infer information from the unified representation 210, and visualization 222 can occur, including performing an interactive analysis on the unified representation 210. Some information can be extracted from biomedical publications and clinical notes 224 and used in the unified representation 210. The processes 218 can include, for example, a continuous link prediction process for rapid knowledge generation by continuously applying data-driven link prediction, text analysis and knowledge visualization and continuously and automatically applying these capabilities over large real-time clinical and molecular data stored in the data warehouse for rapid learning.

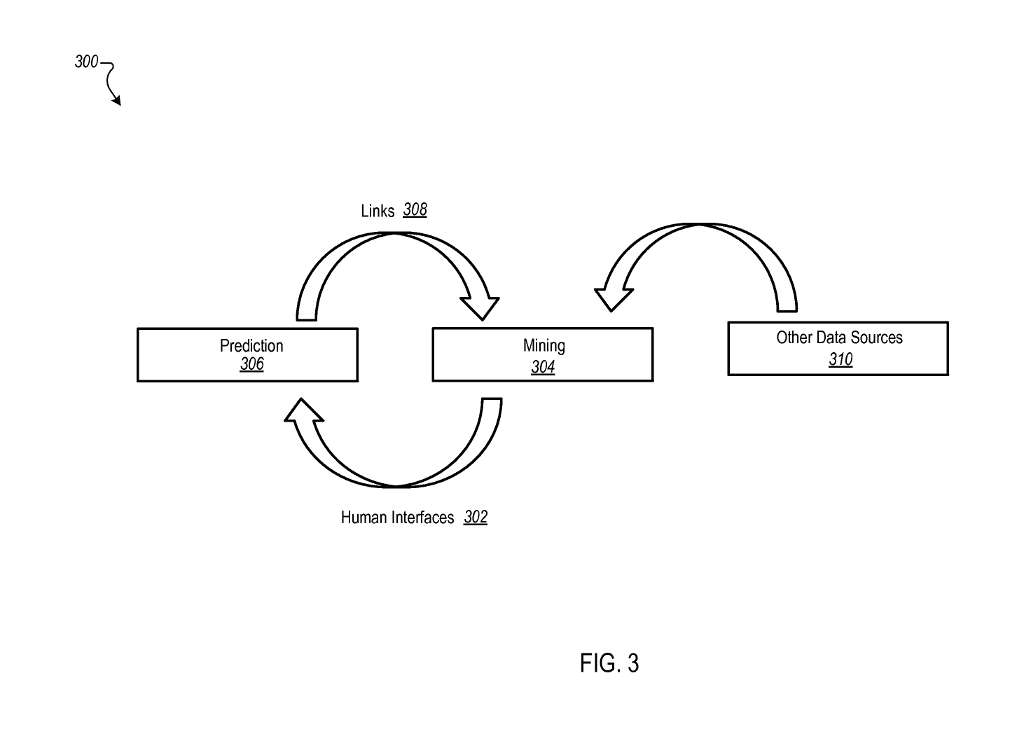

FIG. 3 is a block diagram of an example process 300 for providing real-time decision support for healthcare providers and patients. For example, the process 300 can provide a continuous link prediction using an evidence knowledgebase. As shown in FIG. 3, the system can use a continuous link prediction process for rapid knowledge generation by continuously applying data-driven link prediction, text analysis and knowledge visualization. Further, these capabilities can be continuously and automatically applied over large real-time clinical and molecular data for rapid learning. An example application of this approach can include evidence generation for individual cancer patients based on data and outcomes analysis of patients previously enrolled in the data warehouse. The evidence can be used for treatment matching, including matching to clinical trials, and for comparative effectiveness research. For example, human interfaces 302 can be used with data mining 304 to generate predictions 306. Links 308 can be used to correlate the predictions 306 with data mining (e.g., using the data warehouse). Other data sources 310 can also be used in the process 300.

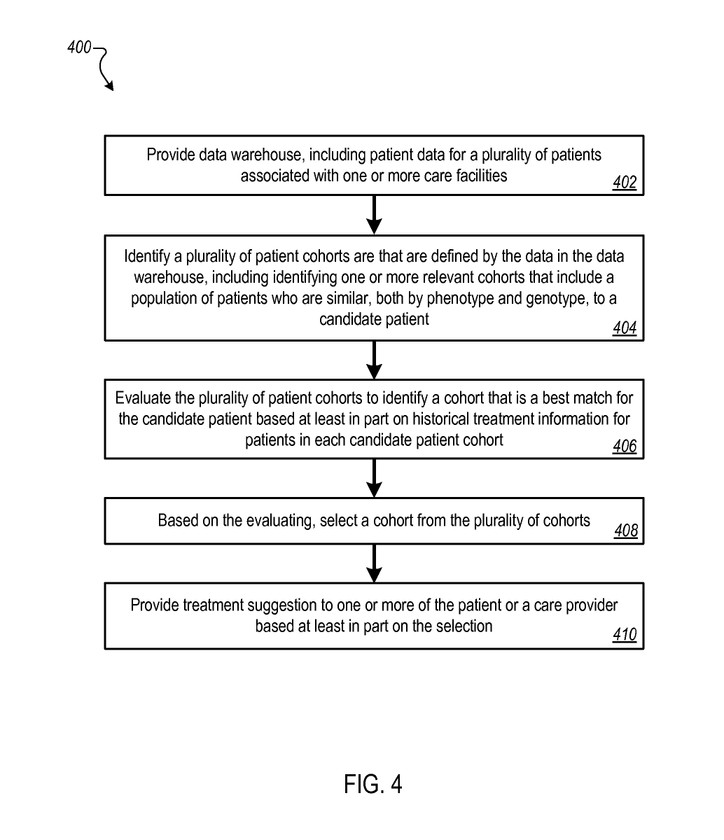

FIG. 4 is a flow diagram of an example process 400 for providing treatment suggestions. In some implementations, the EBCD engine 102 can perform steps of the process 400 using instructions that are executed by one or more processors. FIGS. 1-3 are used to provide example structures for performing the steps of the process 400.

A data warehouse is provided, including patient data for a plurality of patients associated with one or more care facilities (402). For example, the system 200 can include the total cancer care (TCC) data warehouse (DW) 202 that includes patient information provided by patients 108 and provider information provided by healthcare providers 110.

In some implementations, the data warehouse can include clinical data and molecular profiling data that are linked to a patient identifier. For example, the data warehouse can include information associated with patients seen at points of care (e.g., clinics, hospitals, patients' homes, and other locations). The patients' clinical data (e.g., personal medical history, physical exam results, laboratory results, imaging results, and other standard data associated with care of the patient to include but not be limited to past and current medications, surgeries, and other forms of therapy) and molecular profiling data (e.g., gene sequencing data, gene expression data and any -omics data) can be linked using a patient identifier.

A plurality of patient cohorts are identified that are defined by the data in the data warehouse, including identify one or more relevant cohorts that include a population of patients who are similar, both by phenotype and genotype, to a candidate patient (404). For example, using one or both of the portals 104 and 106, information associated with groups of patients can be entered, or the information can be provided by, or available from, other sources and stored in the data warehouse, and displayed using the portals 104 and 106.

In some implementations, identifying the plurality of cohorts can be based, at least in part, on one or more of cultural, socioeconomic, psychological, environmental or other factors that influence patient outcomes. For example, information about the cohorts can include statistically-gathered and patient-provided information such as age, gender, race, nationality, income, geographic region and other factors that may be used to differentiate and/or correlate patients (e.g., of clinical trials or studies).

The plurality of patient cohorts are evaluated to identify a cohort that is a best match for the candidate patient based at least in part on historical treatment information for patients in each candidate patient cohort (406). For example, the EBCD engine 102 can compare information associated the candidate patient with historical treatment information stored in the data warehouse for the plurality of patient cohorts, such as to identify at least one cohort who is a best match with the candidate patient. The best match, for example, can be a cohort whose initial diagnosis matches that of the candidate patient and for which a similar course of treatment for the candidate patient can have a probability of providing comparable results.

Based on the evaluating, a cohort is selected from the plurality of cohorts (408). For example, the EBCD engine 102 can select the cohort who is the best match.

A treatment suggestion is provided to one or more of the patient or a care provider based at least in part on the selection (410). For example, using treatment information stored for the cohort, the EBCD engine 102 can access and analyze treatment information that is applicable to the candidate patient and based on the cohort's treatment. A resulting treatment suggestion can be provided to the candidate patient (e.g., in the patient portal 104) and/or to the candidate patient's physician (e.g., in the healthcare provider portal 106).

In some implementations, providing the treatment suggestion can include capturing information for storage in the data warehouse from disparate sources, including patient derived clinical data, tissue data, and genomic or molecular data, as well as data from open sources including publications and open source databases. For example, when generating the treatment suggestion, the EBCD engine 102 can use information from the data warehouse 202 and/or other sources. The other sources can include, for example, biomedical publications and clinical notes 224, medical information available over a network (e.g., the Internet), and other sources.

In some implementations, the method can further include tracking patients whose data is included in the data warehouse including tracking patients longitudinally throughout their lifetime. For example, once candidate patients become actual patients, information about the patients can be collected over time by the EBCD engine 102 and used to document current and subsequent conditions and treatments. Further, candidate patients or groups of such can serve as potential cohorts for subsequent candidate patients. In some implementations, patients and cohorts can designate how their information is used, and information can be anonymized and/or protected, including based on government laws and regulations.

In some implementations, providing the treatment suggestion can include routinely capturing data for patients, analyzing the captured data, generating evidence through retrospective analysis of existing data as well as data from prospective studies, implementing new insights into subsequent clinical care of one or more patient, evaluating outcomes from changes in clinical practice, and generating new hypotheses for investigation. For example, on an ongoing basis, information about patients' treatments and outcomes can be captured, stored and analyzed by the EBCD engine 102. The information can be used to generate hypotheses about former, current and potential courses of treatment, e.g., that can be used in generating future treatment suggestions.

In some implementations, the method can further include aggregating patient-level data, identifying population-level based change, and applying results in the form of suggestions to care for individual patients to achieve best outcomes based on previous patient outcomes. For example, the EBCD engine 102 can use information for groups of patients in order to change treatment plans for groups of patients or for a particular patient.

In some implementations, the method can further include developing therapeutic and long-term treatment plans based on the past experience of similar patients existing in the data warehouse who are most similar to the candidate patient. As an example, the EBCD engine 102 can generate or modify treatment plans for population groups that include patients who are most like the candidate patient.

In some implementations, the method can further include utilizing a continuous link prediction process for rapid knowledge generation by continuously applying data-driven link prediction, text analysis and knowledge visualization and continuously, and automatically applying these capabilities over large real-time clinical and molecular data stored in the data warehouse for rapid learning. For example, the process 300 or other processes can be used by the EBCD engine 102 to continuously improve treatment plans for patients, as described above with respect to FIG. 3.

In some implementations, the method can further include producing evidence generation for individual cancer patients based on data and outcomes analysis of patients previously enrolled in the data warehouse. As an example, the EBCD engine 102 can analyze treatment and outcome data for patients who have previously been enrolled in studies and/or courses of treatment to identify suggested treatments for cancer patients.

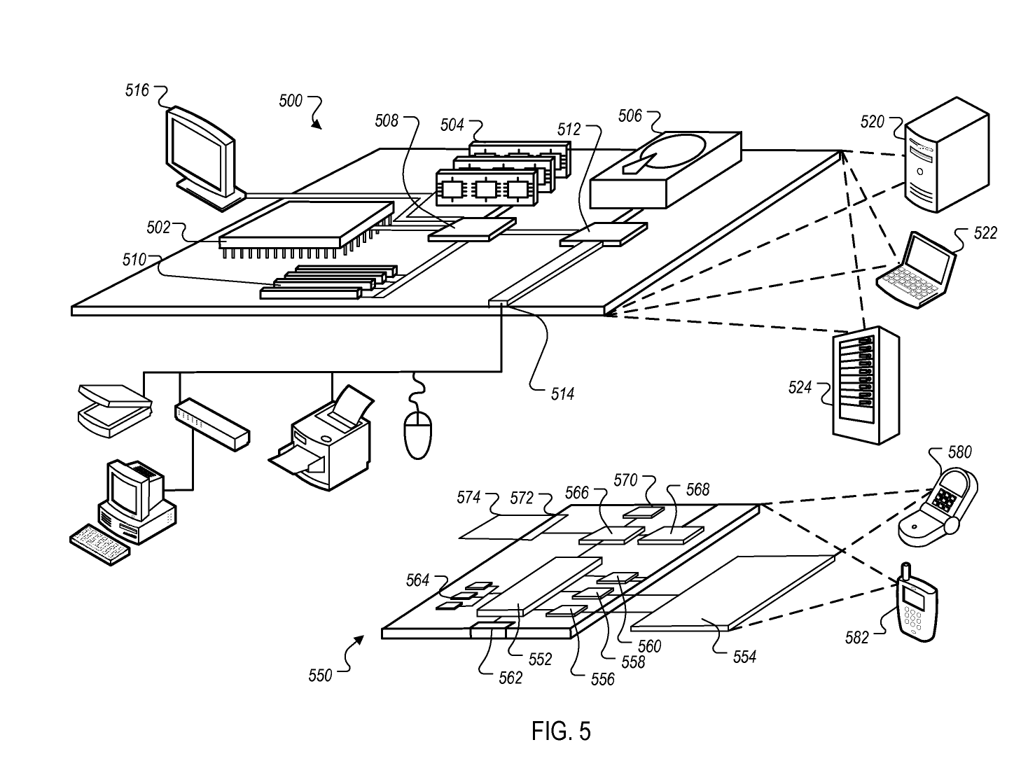

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 500 is further intended to represent any other typically non-mobile devices, such as televisions or other electronic devices with one or more processers embedded therein or attached thereto. Computing device 550 is intended to represent various forms of mobile devices, such as personal digital assistants, cellular telephones, smartphones, and other computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a subscriber identification module (SIM) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
a data warehouse including patient data for a plurality of patients associated with one or more care facilities; and
one or more processors including instructions for implementing an evidence-based clinical decision engine, the engine operable to:
identify a plurality of patient cohorts that are defined by the data in the data warehouse including identify one or more relevant cohorts that include a population of patients who are similar, both by phenotype and genotype, to a candidate patient;
evaluate the plurality of patient cohorts to identify a cohort that is a best match for the candidate patient based at least in part on historical treatment information for patients in each candidate patient cohort;
based on the evaluating, select a cohort from the plurality of cohorts; and
provide a treatment suggestion to one or more of the patient or a care provider based at least in part on the selection.

2. The system of claim 1 wherein the plurality of cohorts are based at least in part on one or more of cultural, socioeconomic, psychological, environmental or other factors that influence patient outcomes.

3. The system of claim 1 wherein the data warehouse includes clinical data and molecular profiling data that is linked to a patient identifier.

4. The system of claim 1 wherein the engine is enabled to capture information for storage in the data warehouse from disparate sources, including patient derived clinical data, tissue data, and genomic or molecular data, as well as data from open sources including publications and open source databases.

5. The system of claim 1 further comprising a computer network for tracking patients whose data is included in the data warehouse including tracking patients longitudinally throughout their lifetime.

6. The system of claim 1 wherein the engine is further operable to routinely capture data for patients; analyze captured data; generate evidence through retrospective analysis of existing data as well as data from prospective studies; implement new insights into subsequent clinical care of one or more patient; evaluating outcomes from changes in clinical practice; and generate new hypotheses for investigation.

7. The system of claim 1 wherein the engine is operable to aggregate patient-level data, identify population-level based change, and apply results in the form of suggestions to care for individual patients to achieve best outcomes based on previous patient outcomes.

8. The system of claim 1 wherein the engine is operable to develop therapeutic and long-term treatment plans based on the past experience of similar patients existing in the data warehouse who are most similar to the candidate patient.

9. The system of claim 1 wherein the engine utilizes a continuous link prediction process for rapid knowledge generation by continuously applying data-driven link prediction, text analysis and knowledge visualization and continuously and automatically applying these capabilities over large real-time clinical and molecular data stored in the data warehouse for rapid learning.

10. The system of claim 1 wherein the engine produces evidence generation for individual cancer patients based on data and outcomes analysis of patients previously enrolled in the data warehouse.

11. A computer-implemented method comprising:
providing a data warehouse including patient data for a plurality of patients associated with one or more care facilities;
identifying a plurality of patient cohorts that are defined by the data in the data warehouse including identify one or more relevant cohorts that include a population of patients who are similar, both by phenotype and genotype, to a candidate patient;
evaluating the plurality of patient cohorts to identify a cohort that is a best match for the candidate patient based at least in part on historical treatment information for patients in each candidate patient cohort;
based on the evaluating, selecting a cohort from the plurality of cohorts; and
providing a treatment suggestion to one or more of the patient or a care provider based at least in part on the selection.

12. The method of claim 11 wherein the plurality of cohorts are based at least in part on one or more of cultural, socioeconomic, psychological, environmental or other factors that influence patient outcomes.

13. The method of claim 11 wherein the data warehouse includes clinical data and molecular profiling data that is linked to a patient identifier.

14. The method of claim 11 wherein providing includes capturing information for storage in the data warehouse from disparate sources, including patient derived clinical data, tissue data, and genomic or molecular data, as well as data from open sources including publications and open source databases.

15. The method of claim 11 further comprising tracking patients whose data is included in the data warehouse including tracking patients longitudinally throughout their lifetime.

16. The method of claim 11 wherein providing includes routinely capturing data for patients; analyzing the captured data; generating evidence through retrospective analysis of existing data as well as data from prospective studies; implementing new insights into subsequent clinical care of one or more patient; evaluating outcomes from changes in clinical practice; and generating new hypotheses for investigation.

17. The method of claim 11 further comprising aggregating patient-level data, identifying population-level based change, and applying results in the form of suggestions to care for individual patients to achieve best outcomes based on previous patient outcomes.

18. The method of claim 11 further comprising developing therapeutic and long-term treatment plans based on the past experience of similar patients existing in the data warehouse who are most similar to the candidate patient.

19. The method of claim 1 further comprising utilizing a continuous link prediction process for rapid knowledge generation by continuously applying data-driven link prediction, text analysis and knowledge visualization and continuously and automatically applying these capabilities over large real-time clinical and molecular data stored in the data warehouse for rapid learning.

20. The method of claim 11 further comprising producing evidence generation for individual cancer patients based on data and outcomes analysis of patients previously enrolled in the data warehouse.
